(19) United States
(12) Patent Application Publication
(10) Pub. No.: US 2019/0050793 A1
(43) Pub. Date: Feb. 14, 2019

(54) SHELF LIFE ESTIMATION SYSTEM

(71) Applicant: Carrier Corporation, Palm Beach Gardens, FL (US)

(72) Inventors: Ciara Poolman, Syracuse, NY (US); Robert A. Chopko, Baldwinsville, NY (US); James J. Minard, Roscoe, IL (US); Renee A. Eddy, Manlius, NY (US); Murat Yasar, West Hartford, CT (US); Marc Beasley, Beverly, MA (US); Mark E. Cywilko, Jamesville, NY (US); Jeffrey Allen Leshuk, Davis, CA (US)

(21) Appl. No.: 16/076,898

(22) PCT Filed: Feb. 1, 2017
(86) PCT No.: PCT/US2017/015994

§ 371 Date: Aug. 9, 2018

Related U.S. Application Data
(60) Provisional application No. 62/294,703, filed on Feb. 12, 2016.

(51) Int. Cl. G06Q 10/08; G06Q 10/06

(52) U.S. Cl. CPC G06Q 10/087; G06Q 10/0832; G06Q 10/0833; G06Q 10/0631

(57) ABSTRACT

A method and system to provide an estimated shelf life value for a product to a user includes at least one information source to provide at least one product information entry for the product, and a shelf life estimation system, including a processor to receive and analyze the at least one product information entry from the at least one information source, and to provide the estimated shelf life value to the user.

### DESCRIPTION OF RELATED ART

The subject matter disclosed herein relates to providing an estimated shelf life to a user, and to a system and a method for providing an estimated shelf life with information from multiple sources to a user.

Typically, cold chain distribution systems are used to transport and distribute temperature sensitive and perishable goods. For example, products such as food and pharmaceuticals may be susceptible to temperature, humidity, contaminants, and other environmental factors. Advantageously, cold chain systems allow perishable and environmentally sensitive goods to be effectively transported and distributed without damage or other undesirable effects.

However, users of cold chain systems may estimate shelf life of products using limited information. Various environmental and product factors may affect the shelf life of a product. A system and method that can provide an estimated shelf life with information from multiple sources to a user is desired.

### BRIEF SUMMARY

According to an embodiment, a system to provide an estimated shelf life value for a product to a user includes at least one information source to provide at least one product information entry for the product, and a shelf life estimation system, including a processor to receive and analyze the at least one product information entry from the at least one information source, and to provide the estimated shelf life value to the user.

In addition to one or more of the features described above, or as an alternative, further embodiments could include that the at least one information source includes at least one of a grower information system, a transportation information system, a tracking information system, a warehousing information system, and an inventory information system.

In addition to one or more of the features described above, or as an alternative, further embodiments could include that the at least one product information entry includes at least one of a product origin entry, a transport time entry, an environmental exposure entry, and a usage information entry.

In addition to one or more of the features described above, or as an alternative, further embodiments could include that the at least one information source includes a shelf life feedback system, including a shelf life feedback processor to receive and analyze at least one feedback information entry from at least one consumer feedback source, and to provide a shelf life feedback value to the shelf life estimation system.

In addition to one or more of the features described above, or as an alternative, further embodiments could include that the at least one consumer feedback source includes at least one of a social media source, a consumer application source and a structured data source.

In addition to one or more of the features described above, or as an alternative, further embodiments could include that the shelf life feedback processor utilizes at least one machine learning algorithm to provide the shelf life feedback value.

In addition to one or more of the features described above, or as an alternative, further embodiments could include a shelf life feedback interface to receive the at least one feedback information entry.

In addition to one or more of the features described above, or as an alternative, further embodiments could include that the shelf life feedback interface presents at least one decision junction to the user.

In addition to one or more of the features described above, or as an alternative, further embodiments could include that the shelf life feedback interface utilizes at least one of a probabilistic model and a deterministic model.

According to an embodiment, a method to provide an estimated shelf life value for a product to a user includes providing at least one product information entry for the product via at least one information source, receiving the at least one product information entry for the product from the at least one information source via a processor, analyzing the at least one product information entry for the product from the at least one information source via the processor, and providing the estimated shelf life value to the user via the processor.

In addition to one or more of the features described above, or as an alternative, further embodiments could include providing at least one feedback information entry for the product via at least one consumer feedback source, receiving the at least one feedback information entry for the product from the at least one consumer feedback source via a shelf life feedback processor, analyzing the at least one feedback information entry for the product from the at least one consumer feedback source via the shelf life feedback processor, and providing a shelf life feedback value to the shelf life estimation system.

In addition to one or more of the features described above, or as an alternative, further embodiments could include that the at least one consumer feedback source includes at least one of a social media source, a consumer application source and a structured data source.

In addition to one or more of the features described above, or as an alternative, further embodiments could include that the shelf life feedback processor utilizes at least one machine learning algorithm to provide the shelf life feedback value.

In addition to one or more of the features described above, or as an alternative, further embodiments could include receiving the at least one feedback information entry via a shelf life feedback interface.

In addition to one or more of the features described above, or as an alternative, further embodiments could include that the shelf life feedback interface presents at least one decision junction to the user.

Technical function of the embodiments described above includes a processor to receive and analyze the at least one product information entry from the at least one information source, and to provide the estimated shelf life value to the user.

Other aspects, features, and techniques of the embodiments will become more apparent from the following description taken in conjunction with the drawings.

### BRIEF DESCRIPTION OF THE SEVERAL VIEWS OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the several FIGURES:

FIG. 1 illustrates a schematic view of a product information system; and

FIG. 2 is a flow diagram of a method of providing a shelf life estimate for a product to a user.

### DETAILED DESCRIPTION

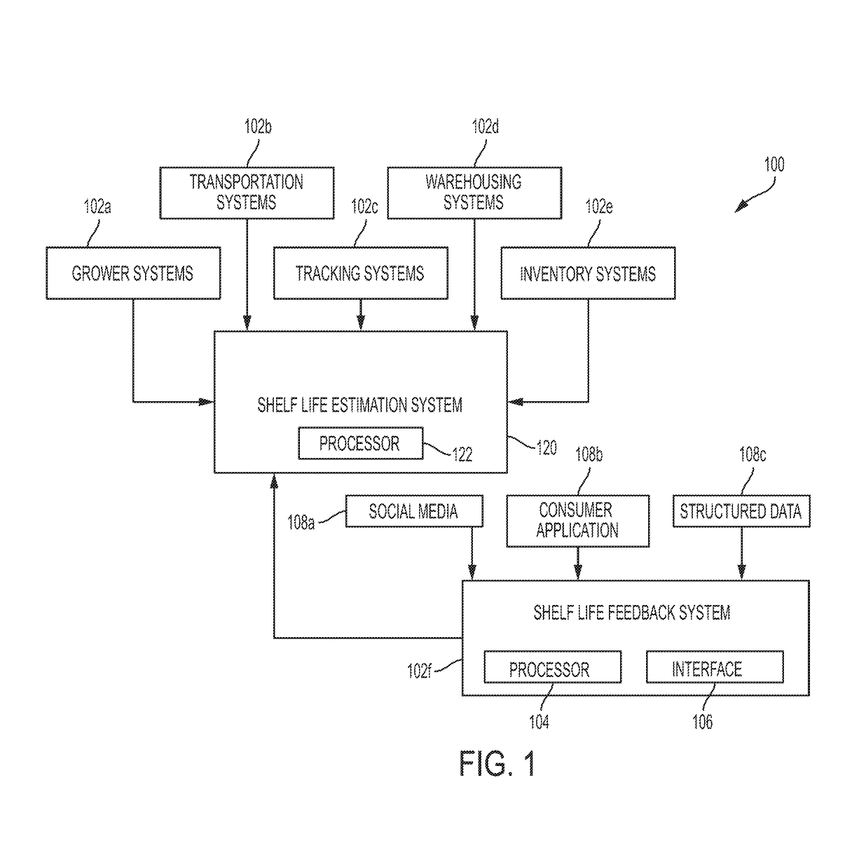

Referring now to the drawings, FIG. 1 illustrates a schematic view of the product information system 100. In the illustrated embodiment, the product information system 100 includes at least one information source 102a-120f and a shelf life estimation system 120. In the illustrated embodiment, the product information system 100 can be used to provide product information such as estimated shelf life to a user. Advantageously, the product information system 100 can provide shelf life estimates for the products utilizing information received from all aspects of the cold chain distribution system.

In the illustrated embodiment, the information sources 102a-102f can include, but are not limited to, grower information systems 102a, transportation information systems 102b, tracking information systems 102c, warehousing information systems 102d, inventory information systems 102e, and a shelf life feedback system 102f. In the illustrated embodiment, the product information system 100 can include any suitable type and number of information sources not limited to those described herein. In the illustrated embodiment, the information sources 102a-102f can be isolated information sources, while in other embodiments, the information sources 102a-102f may be interconnected. In the illustrated embodiment, the information sources 102a-102f can each provide isolated or otherwise unassociated product information entries relevant to the product within the cold chain distribution system. In the illustrated embodiment, the product information entries can include, but are not limited to, temperatures, humidity levels, ethylene levels, shock values, excursions beyond prescribed parameters, excursion duration, etc.

In the illustrated embodiment, the product information system 100 includes a grower information system 102a. In the illustrated embodiment, the grower information system 102a can supply information from the grower to the data warehouse 120. In certain embodiments, the grower can supply initial information about the product such as the type, quality, quantity, etc. of the product being distributed within the cold chain distribution system. In certain embodiments, the grower information system 102a can provide product information entries regarding the temperature of the product as the products are picked up for distribution, if the products were refrigerated while awaiting pick up, etc.

In the illustrated embodiment, the product information system 100 includes a transportation information system 102b. In the illustrated embodiment, the transportation information system 102b can provide information received during transport to the data warehouse 120. Product information entries from the transportation information system 102b can include, but are not limited to, refrigeration conditions in the trailer such as temperature, humidity, etc. In the illustrated embodiment, the transportation information system 102b can further provide additional transportation parameters, include transport time, temperature excursions and durations thereof, if the trailer door has been opened and durations thereof.

In the illustrated embodiment, the product information system 100 can further include a tracking information system 102c. In the illustrated embodiment, the tracking information system 102c can include GPS position data independent from the transportation information system 102b. Further, the tracking information system 102c can further provide climate data both within the cold chain and outside of the containers. In certain embodiments, outside temperature data may be used to determine a door open condition, etc. affect the quality of the product. In certain embodiments, the information from multiple systems such as the transportation information system 102b and the tracking information system 102c can be used to cross check data. Further, in certain embodiments, the tracking information system 102c can utilize embedded or dedicated sensors that are associated with the product to travel with the product for the entire duration of the distribution.

In the illustrated embodiment, the product information system 100 includes a warehousing information system 102d. In the illustrated embodiment, the warehousing information system 102d can provide information entries regarding the reception and storage of a product. For example, the warehousing information system 102d can provide information entries regarding the time of receipt of a product from a climate controlled container, if the product was left outside of a climate controlled area, and a duration thereof. Further information can include the ambient dock temperature, ambient humidity, etc.

In the illustrated embodiment, the product information system 100 includes an inventory information system 102e. In the illustrated embodiment, the inventory information system 102e can provide a product location, a product age, a product temperature, a product humidity, etc. In the illustrated embodiment, the inventory information system 102e can provide product aging information to determine the best time to distribute a product to allow the product to arrive at a desired time or a desired condition such as desired ripeness, etc.

In the illustrated embodiment, the product information system 100 includes a shelf life feedback system 102f. In the illustrated embodiment, the shelf life feedback system 102f includes a processor 104 and an interface 106. The shelf life feedback system 102f can interface with the shelf life estimation system 120 to provide feedback or adjustments to estimated feedback values regarding the shelf life of products previously estimated by the shelf life estimation system 120. In the illustrated embodiment, the shelf life feedback system 102f can collect and provide the consumer feedback to the shelf life estimation system 120 to adjust shelf life estimates values.

In the illustrated embodiment, feedback information entries can be provided regarding the actual experienced shelf life compared to the estimated shelf life via sources of feedback 108a-108c. Feedback sources can include social media 108a, consumer applications 108b, and structured data sources 108c. In certain embodiments, the feedback sources 108a-108c can provide additional information regarding products and current status to update and provide more accurate estimated shelf life based on current conditions. The feedback sources 108a-108c can provide textual, visual, photographical, video, or other data regarding the experienced shelf life or current condition of products experienced by consumers and other users. In certain embodiments, the feedback sources 108a-108c can utilize metadata such as geotags, date taken, comments, etc.

In the illustrated embodiment, the shelf life feedback system 102f can receive information from a social media source 108a. In certain embodiments, social media sources 108a can identify submitted photographs, comments, and other media available on public social media or content directed to designated social media accounts. In certain embodiments, additional information such as geolocation, time of photo, etc. can be obtained. In certain embodiments, the processor 104 can identify relevant products within social media content. In other embodiments, consumers may direct social media content to a social media account of an interested party. After relevant content is identified, the processor 104 can assess the experienced shelf life as well as remaining shelf life using machine learning techniques and feedback provided by social media users.

In the illustrated embodiment, the shelf life feedback system 102f can receive information from a consumer application 108b. The consumer application 108b can be a dedicated application to provide feedback to an interested user. In certain embodiments, the consumer application 108b can be located on a phone, computer, tablet or any other suitable device. The consumer application 108b can receive feedback from an end user to identify if a product was satisfactory, unsatisfactory, etc. Feedback prompts and other techniques described for with respect to the interface 106 can be used at decision junctions to guide and prompt the user to provide useful feedback.

In the illustrated embodiment, the shelf life feedback system 102f can further utilize structured data from structured data sources 108c such as laboratory data, producer data, etc.

In the illustrated embodiment, the processor 104 can receive information from various sources of feedback 108a-108c to receive, process, and prioritize feedback received from consumers and other feedback sources. The processor 104 can identify and qualify feedback and further identify erroneous or outlier feedback data. In the illustrated embodiment, the processor 104 can determine appropriate suggested adjustment values for the provided estimates based on information received from the feedback sources 108a-108c.

In the illustrated embodiment, the interface 106 can provide and receive information to and from the feedback sources 108a-108c. The interface 106 can receive information provided by the feedback sources 108a-108c. In certain embodiments, the interface 106 can further provide guidance and assistance by prompting users to determine a condition of the product to properly evaluate the condition of the product.

For example, the interface 106 can provide guidelines or prompts to determine a condition of the product experienced by the consumer. The interface 106 can work in conjunction with the processor 104 to provide heuristics, decision trees, process flow charts, etc., to determine a quality of a product by guiding and collecting inputs at each decision junction. In the illustrated embodiment, the interface 106 can provide procedures to determine proper conditions by providing comparison photos or instructions (such as rating a product from 1-10). In certain embodiments, the interface 106 can utilize probabilistic methods, such as utilizing Markov decision processes. In other embodiments, the interface can utilize deterministic methods such as using finite state automation. In certain embodiments, the interface can utilize a feedback loop to use a learning algorithm to determine a condition of a product.

In the illustrated embodiment, the shelf life estimation system 120 includes a processor 122. The shelf life estimation system 120 can receive product information entries from various information sources 102a-102f, analyze the product information entries and utilize predictive models to determine an estimated shelf life of a product. Advantageously, the shelf life estimation system can utilize information from multiple sources using parameters to provide a simplified and more accurate estimated shelf life. In certain embodiments, the shelf life estimation system 120 can adjust shelf life estimates based on feedback received from the shelf life feedback system 102f. In certain embodiments, the processor 122 can analyze product information entries and feedback received from the shelf life feedback system 102f to modify and adapt the predictive models used to determine the estimated shelf life of the product.

In the illustrated embodiment, the processor 122 can receive product information entries from the plurality of information sources 102a-102f. The processor 122 can utilize product information entries such as temperatures, environmental conditions, trailer conditions, etc., to determine estimated shelf life. Accordingly, the processor 122 can analyze information received from information sources 102a-102f.

In the illustrated embodiment, the processor 122 can utilize algorithms to estimate remaining shelf life. In certain embodiments, the processor 122 can utilize machine learning algorithms to learn and adapt predictive data models. In certain embodiments, the processor 122 can utilize laboratory data to obtain models and make adjustments to shelf life estimates. In certain embodiments, the processor 122 can be located on local servers, a cloud service, or a big data technology stack. Advantageously, the processor 122 can perform and tailor shelf life estimates for products based on experienced conditions instead of utilizing and adapting previous laboratory results.

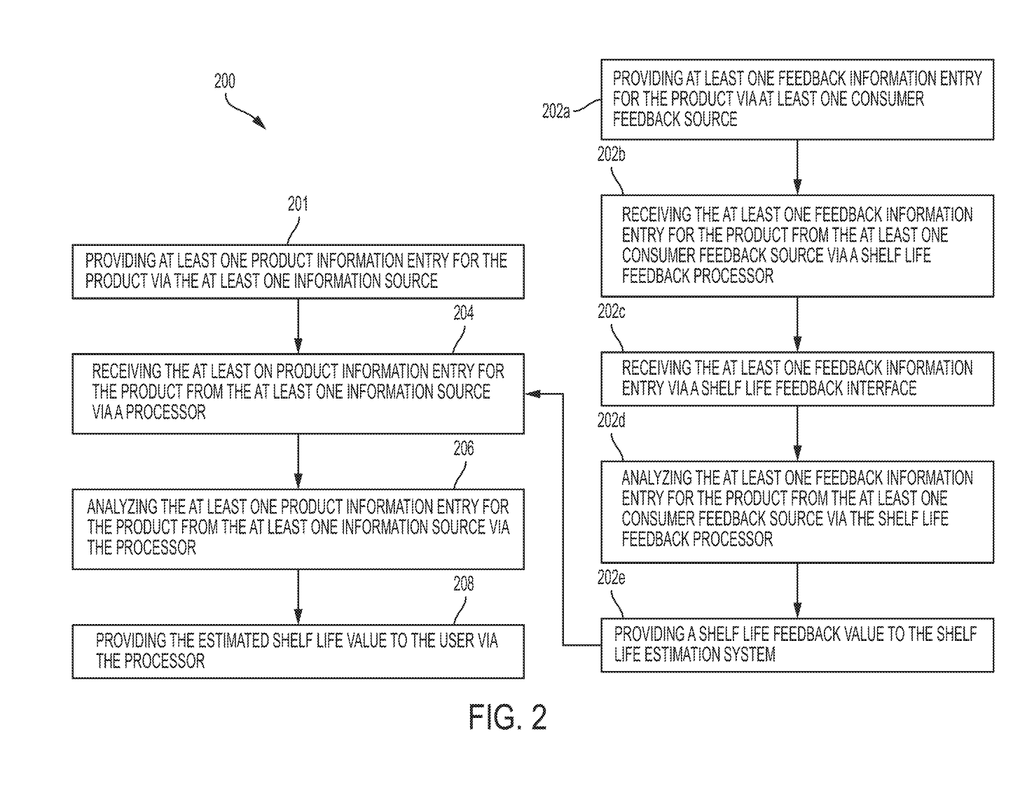

Referring to FIG. 2, a method 200 for providing a shelf life estimate for a product to a user is described. In operation 201, at least one product information entry for the product is provided via the at least one information source. In the illustrated embodiment, the information sources can include, but are not limited to, grower information systems, transportation information systems, tracking information systems, warehousing information systems, inventory information systems, and a shelf life feedback system.

In operation 202a, at least one feedback information entry for the product is provided via at least one consumer feedback source. In the illustrated embodiment, feedback information entries can be provided regarding the actual experienced shelf life compared to the estimated shelf life via sources of feedback. Feedback sources can include social media, consumer applications, and structured data sources. In certain embodiments, the feedback sources can provide additional information regarding products and current status to update and provide more accurate estimated shelf life based on current conditions.

In operation 202b, the at least one feedback information entry for the product from the at least one consumer feedback source is received via a shelf life feedback processor.

In operation 202c the at least one feedback information entry is received via a shelf life feedback interface. In operation 202d the at least one feedback information entry for the product from the at least one consumer feedback source is analyzed via the shelf life feedback processor. In certain embodiments, the shelf life estimation system can adjust shelf life estimates based on feedback received from the shelf life feedback system. In operation 202e a shelf life feedback value is provided to the shelf life estimation system.

In operation 204 the at least one product information entry for the product from the at least one information source is received via a processor.

In operation 206 the at least one product information entry for the product from the at least one information source is analyzed via the processor. The shelf life estimation system can receive product information entries from various information sources, analyze the product information entries and utilize predictive models to determine an estimated shelf life of a product.

In operation 208 the estimated shelf life value to the user is provided via the processor. Advantageously, the processor can perform and tailor shelf life estimates for products based on experienced conditions instead of utilizing and adapting previous laboratory results.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope of the embodiments. Additionally, while various embodiments have been described, it is to be understood that aspects may include only some of the described embodiments. Accordingly, the embodiments are not to be seen as limited by the foregoing description, but are only limited by the scope of the appended claims.

1. A system to provide an estimated shelf life value for a product to a user, the system comprising:
at least one information source to provide at least one product information entry for the product; and
a shelf life estimation system, comprising:
a processor to receive and analyze the at least one product information entry from the at least one information source, and to provide the estimated shelf life value to the user.

2. The system of claim 1, wherein the at least one information source includes at least one of a grower information system, a transportation information system, a tracking information system, a warehousing information system, and an inventory information system.

3. The system of claim 1, wherein the at least one product information entry includes at least one of a product origin entry, a transport time entry, an environmental exposure entry, and a usage information entry.

4. The system of claim 1, wherein the at least one information source includes a shelf life feedback system, comprising:
a shelf life feedback processor to receive and analyze at least one feedback information entry from at least one consumer feedback source, and to provide a shelf life feedback value to the shelf life estimation system.

5. The system of claim 4, wherein the at least one consumer feedback source includes at least one of a social media source, a consumer application source and a structured data source.

6. The system of claim 4, wherein the shelf life feedback processor utilizes at least one machine learning algorithm to provide the shelf life feedback value.

7. The system of claim 4, the shelf life feedback system further includes a shelf life feedback interface to receive the at least one feedback information entry.

8. The system of claim 7, wherein the shelf life feedback interface presents at least one decision junction to the user.

9. The system of claim 7, wherein the shelf life feedback interface utilizes at least one of a probabilistic model and a deterministic model.

10. A method to provide an estimated shelf life value for a product to a user, the method comprising:
providing at least one product information entry for the product via at least one information source;
receiving the at least one product information entry for the product from the at least one information source via a processor;
analyzing the at least one product information entry for the product from the at least one information source via the processor; and
providing the estimated shelf life value to the user via the processor.

11. The method of claim 10, further comprising:
providing at least one feedback information entry for the product via at least one consumer feedback source;
receiving the at least one feedback information entry for the product from the at least one consumer feedback source via a shelf life feedback processor;
analyzing the at least one feedback information entry for the product from the at least one consumer feedback source via the shelf life feedback processor; and
providing a shelf life feedback value to the shelf life estimation system.

12. The method of claim 11, wherein the at least one consumer feedback source includes at least one of a social media source, a consumer application source and a structured data source.

13. The system of claim 11, wherein the shelf life feedback processor utilizes at least one machine learning algorithm to provide the shelf life feedback value.

14. The method of claim 11, further comprising receiving the at least one feedback information entry via a shelf life feedback interface.

15. The method of claim 14, wherein the shelf life feedback interface presents at least one decision junction to the user.
